(19) United States
(12) Patent Application Publication
(10) Pub. No.: US 2010/0071325 A1
(43) Pub. Date: Mar. 25, 2010

(54) AIR FILTRATION SYSTEM AND METHOD

(76) Inventor: John R. Walker, Minneapolis, MN (US)

Correspondence Address: LEMAIRE PATENT LAW FIRM, P.L.L.C., P.O. BOX 1818, BURNSVILLE, MN, 55337, US

(21) Appl. No.: 12/628,953

(22) Filed: Dec. 1, 2009

Related U.S. Application Data
(62) Division of application No. 11/742,585, filed on Apr. 30, 2007.

(51) Int. Cl. B01D 46/10; F24F 13/28; B29C 65/00

(52) U.S. Cl. 55/496; 55/505; 156/66

(57) ABSTRACT

An air-filtration system and method for removably attaching a filter element to portable air-circulation devices and building HVAC air-intakes. One such system provides a filter portion having a circular outer periphery, an inner periphery, a slit running from the outer periphery to the inner periphery that creates a first and second end of the filter portion, and a plurality of fastening mechanisms. One method includes manufacturing a plurality of air-permeable filter sheets, determining a shape of a portable electric fan that includes a fan cage, a support stand, and a motor casing, measuring a size of an inlet side of the fan cage and a size of the motor casing, cutting the plurality of filter sheets such that a plurality of filter portions are created, and attaching a plurality of fastening mechanisms to each one of the plurality of filter portions.

### CROSS-REFERENCE TO RELATED APPLICATIONS

This is a divisional application of U.S. patent application Ser. No. 11/742,585 entitled “AIR FILTRATION SYSTEM AND METHOD,” filed on Apr. 30, 2007 (Attorney Docket 5071.001US1), which is incorporated herein by reference in its entirety.

### FIELD OF THE INVENTION

The invention relates generally to filtration systems and devices, and more specifically to an air-filtration system which is removably attachable to portable air-circulation devices and air-intakes for heating, ventilating, and air-conditioning (HVAC) systems.

### BACKGROUND OF THE INVENTION

In recent years, people have become more aware of various airborne impurities which are commonly found in indoor environments in the home, office, and other locations. Such impurities range from secondhand tobacco smoke to asbestos dust and other less hazardous materials. Many such hazards, such as those two noted specifically above, are considered to be sufficiently dangerous that indoor smoking has been banned in most areas of the country and considerable sums of money have been spent on asbestos cleanup.

Nonetheless, other undesirable airborne impurities in the form of dust, pollen, etc., generally circulate in most indoor environments, even with centralized filtration systems associated with conventional central heating and air-conditioning systems. Accordingly, various systems and devices have been developed in the past in attempts to filter or clean the ambient air within buildings and/or within relatively small localized areas, such as a rooms or individual office spaces. These devices and systems have generally not provided the efficiency and economy desired in such devices, for various reasons noted further below.

### BRIEF DESCRIPTION OF THE PRIOR ART

One type of localized air-filtration system is a filtering device that attaches to a conventional portable electric fan. Examples of portable fan filters are described in U.S. Pat. Nos. 4,477,272; 5,904,744; 6,045,329; and 6,398,835, each of which is herein incorporated by reference in its entirety.

U.S. Pat. No. 4,477,272 issued Oct. 16, 1984, to Craig E. Hollis et al. (hereinafter “Hollis”), describes a filter with a configuration similar to that of a fan's cage and having a slot extending from its outer periphery to its central area to permit the filter to be slipped over the motor, and is herein incorporated by reference in its entirety. Drawstrings are sewn into the filter about its outer periphery and are used to secure the filter to the fan cage. The Hollis filter does not completely cover the inlet side of the fan cage due to the slot provided in the filter.

U.S. Pat. No. 5,904,744 issued May 18, 1999, to Anton Kagan (hereinafter “Kagan”), describes an air filter designed to be placed at a definite distance L beyond the periphery of the primary airflow which is created by an operating fan, and is herein incorporated by reference in its entirety. The Kagan filter attaches to a stationary element of the fan or to a stationary element of an enclosed space with fasteners which are, at the same time, vibration isolation units. While the Kagan filter might reduce slightly any impurities ejected from the tips of the rotating blades, such air movement is a relatively small volume of the total air moved by a fan or propeller.

U.S. Pat. No. 6,045,329 issued Apr. 4, 2000, to Randy Sobala (hereinafter “Sobala”), describes a filter for a fan comprising air permeable material exteriorally embracing the suction portion of said fan, and is herein incorporated by reference in its entirety. The Sobala filter includes a continuous web of air permeable material which defines a first opening or perimetrical edge and a second opening or perimetrical edge. Each of the openings has stitched thereto a strip of elastic material which causes the openings to expand and contract in size by stretching or relaxing the elastic material. Although the Sobala filter may fit tightly around a fan the first few times it is used, the elasticity in the two openings will decrease over time causing the filter to loosen in certain areas, which leads to filtration inefficiencies. Further, a lot of filter material is needed to provide the ability of installing the filter from the front.

U.S. Pat. No. 6,398,835 issued Jun. 4, 2002, to Om Prakash Rehil (hereinafter “Rehil”), describes an air filtering device that removably attaches to the back or inlet side of the wire guard of a conventional portable desktop electric fan or the like, and is herein incorporated by reference in its entirety. The filter device comprises a filter element and solid shroud, with the shroud capturing the filter element between the back of the fan guard and the inner surface of the shroud. The shroud has an outer rim including attachments for securing the shroud to the outer periphery of the fan guard, and an inner annulus having a lip extending therefrom for securing one annulus of the filter thereto. The Rehil filter does not provide for optimum airflow through the fan because the shroud only allows a small airflow inlet passage through the fan.

### BRIEF SUMMARY OF THE INVENTION

In some embodiments, the invention is an air-filtration system and method for use with a conventional portable electric fan. In some embodiments, the filtration system comprises a first filter made of thin, air-permeable material that is attached to the inlet side of the fan cage and an optional second filter made of thin, air-permeable material that is attached to the air-intake of the fan motor using fastening mechanisms and/or the suction caused by the airflow through the fan and motor.

In some embodiments, the fan cage filter is of an annular shape to fit the back of a fan-blade cage generally toroidal in shape with the inner edge of the annular area being open, and having a slit to the outer edge so that the filter can be fitted around the fan motor and seal up to the motor cover. In some embodiments, there is also a break in the continuity of the filter so that the filter can be fitted around the fan's support stand when connecting the filter to the fan cage inlet. In some embodiments, the fan cage filter secures completely and tightly about the fan motor by fitting the filter around the fan motor and support stand, connecting the ends of the filter together such that the filter forms a continuous filter that covers the entire fan cage inlet, and connecting the continuous filter to the fan cage inlet using fastening mechanisms and/or the suction created by turning the fan on. In some embodiments, double-sided, pressure-sensitive adhesive strips are placed on the back sides of the ends of the fan cage filter in order to connect the two ends together and attach the connected ends to the fan cage after the filter has been fitted around the fan motor.

In some embodiments, the fan motor air-intake filter is shaped such that it covers an area approximately the same size as the fan motor air-intake so that when it is connected to the air-intake, all air-flow through the motor must pass through the filter. In some embodiments, the air-intake filter is connected to the motor air-intake using fastening mechanisms and/or the suction created by turning the fan on.

In some embodiments, the invention is an air filtration system and method for filtering the air entering a building's HVAC system. In some embodiments, a bonnet-shaped filtering element is placed onto the HVAC system's air-intake such that all air entering the air-intake must pass through the filtering element. In some embodiments, the bonnet-shaped filtering element includes a drawstring that is sewn into the edge of the filtering element such that the filtering element can be tightly fitted around the air-intake by tightening the drawstring.

### BRIEF DESCRIPTION OF THE DRAWINGS

FIG. 1 is a schematic view of a fan cage filter with hook and loop strips attached, according to some embodiments of the present invention.

FIG. 2 is a schematic view of a fan motor air-intake filter with a hook and loop strip attached.

FIG. 3 is a perspective view of a portable electric fan having a fan cage, a motor casing, and a support stand, and that will be used with some embodiments of the claimed invention.

FIG. 4 is a perspective view of a portable electric fan with a fan cage filter and motor air-intake filter in place using hook and loop strips.

FIG. 5 is schematic view of a fan cage filter with double-sided, adhesive strips attached.

FIG. 6 is a schematic view of a fan motor air-intake filter with a double-sided, pressure-sensitive adhesive strip attached.

FIG. 7 is a perspective view of a portable electric fan with a fan cage filter and motor air-intake filter in place using double-sided, pressure-sensitive adhesive strips.

FIG. 8 is a schematic view of a hexagonal-shaped filter element for a portable electric fan with slits cut near the points of the hexagon.

FIG. 9 is a perspective view of a hexagonal-shaped filter element with slits cut near the points of the hexagon attached to the inlet side of a fan cage.

FIG. 10 is a schematic view of a hexagonal-shaped filter element for a portable electric fan with slits cut at the points of the hexagon.

FIG. 11 is a perspective view of a hexagonal-shaped filter element with slits cut at the points of the hexagon, folded to the shape attached to the inlet side of a fan cage.

FIG. 12 is a schematic view of a bonnet-shaped filter element.

FIG. 13 is a perspective view of a bonnet-shaped filter element attached to the air-intake of a building's HVAC system.

FIG. 14 is a schematic view of a circular-shaped HVAC air-intake filtration system with slits that have two fastening mechanisms attached to one side of the slit.

FIG. 15 is a schematic view of a circular-shaped HVAC air-intake filter element with slits that have a fastening mechanism attached to both sides of the slit.

FIG. 16A is a perspective view of a circular-shaped HVAC air-intake filter element attached to an HVAC air-intake pipe, where each slit of the filter element has two fastening mechanisms attached to one side of the slit.

FIG. 16B is a perspective view of a circular-shaped HVAC air-intake filter element attached to an HVAC air-intake pipe, where each slit has a fastening mechanism attached to both sides of the slit.

FIG. 17 is a schematic view of a hexagonal-shaped HVAC air-intake filtration system with slits that have two fastening mechanisms attached to one side of the slit.

FIG. 18 is a schematic view of a hexagonal-shaped HVAC air-intake filter element with slits that have a fastening mechanism attached to both sides of the slit.

FIG. 19A is a perspective view of a hexagonal-shaped HVAC air-intake filter element attached to an HVAC air-intake pipe, where each slit of the filter element has two fastening mechanisms attached to one side of the slit.

FIG. 19B is a perspective view of a hexagonal-shaped HVAC air-intake filter element attached to an HVAC air-intake pipe, where each slit has a fastening mechanism attached to both sides of the slit.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Accordingly, the following preferred embodiments of the invention are set forth without any loss of generality to, and without imposing limitations upon the claimed invention.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

In some embodiments, the present invention provides a filter portion, the filter portion including a circular outer periphery, an inner periphery which forms a boundary around an opening in the filter portion, a slit running from the outer periphery to the inner periphery that creates a first end and a second end of the filter portion, and a plurality of fastening mechanisms. In other embodiments, the present invention provides a filter portion, the filter portion including a hexagonal outer periphery (in order to obtain a filter that provides some filtering at the points outside the circular shape of the previous paragraph and make cutting easier and providing less scrap than if the outer edge were a circle), an inner periphery shaped to conform to the fan motor cover which forms a boundary around an opening in the filter portion, a slit running from the outer periphery to the inner periphery that creates a first end and a second end of the filter portion, and a plurality of fastening mechanisms. By providing a circular or hexagonal outer periphery shape that fits across most of the back plane of the fan cage (rather than the “bonnet” shape that wraps at least partially around the central rim (midway between the back plane and the front plane) of the fan cage described in U.S. Pat. No. 6,045,329 by Sobala, which is incorporated by reference), less of the expensive, high-efficiency “electrostatic” allergen-reducing filter material (such as 3M Filtrete™) is needed, providing a more cost-effective filtering solution.

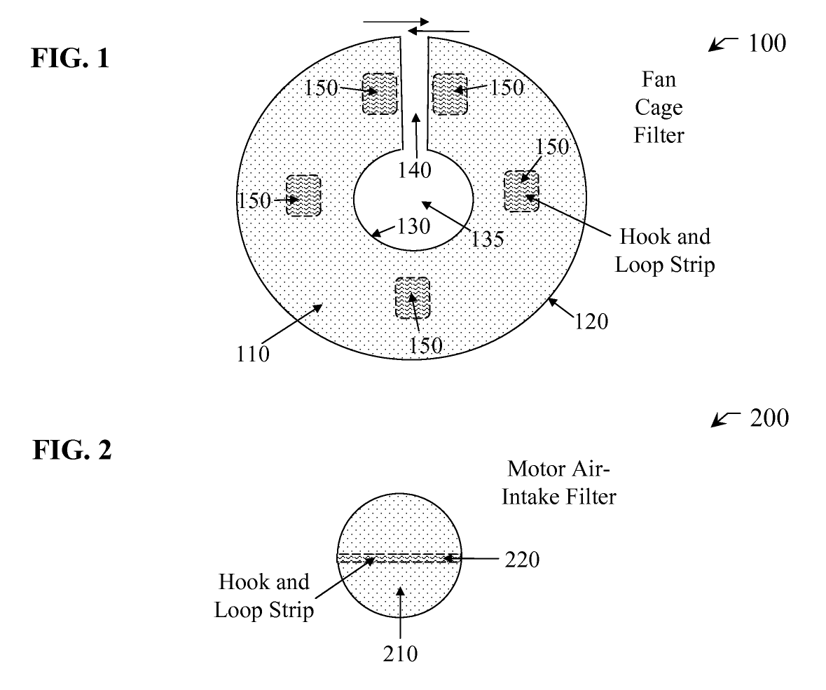

In some embodiments, the filter portion is a fan cage filter 100, as shown in FIG. 1. The fan cage filter 100 has a circular outer periphery 120, an inner periphery 130 which forms a boundary around an opening 135 in the fan cage filter 100, and a slit 140 that runs from the outer periphery 120 to the inner periphery 130 and creates a first end and a second end of the fan cage filter 100. In some embodiments, the fan cage filter 100 has a plurality of fastening mechanisms 150 attached. The plurality of fastening mechanisms 150 allow for easy installation and removal of the fan cage filter 100. In some embodiments, the fastening mechanisms 150 are used to connect the first end and the second end of the fan cage filter 100 by overlapping the two ends together as the fan cage filter 100 is placed on the inlet side of a fan cage. In some embodiments, the fastening mechanisms 150 are also used to attach the fan cage filter 100 to the inlet side of a fan cage. In some embodiments, the fan cage filter 100 is held onto the fan cage via the suction created when the fan is turned on.

In some embodiments, the fastening mechanisms 150 are hook and loop strips and are spaced out on the fan cage filter 100 at twelve o'clock, three o'clock, six o'clock, and nine o'clock, as shown in FIG. 1. In other embodiments, the fastening mechanisms 150 are hook and loop strips and are arranged in some other pattern such that the fan cage filter 100 can be held securely to the fan cage.

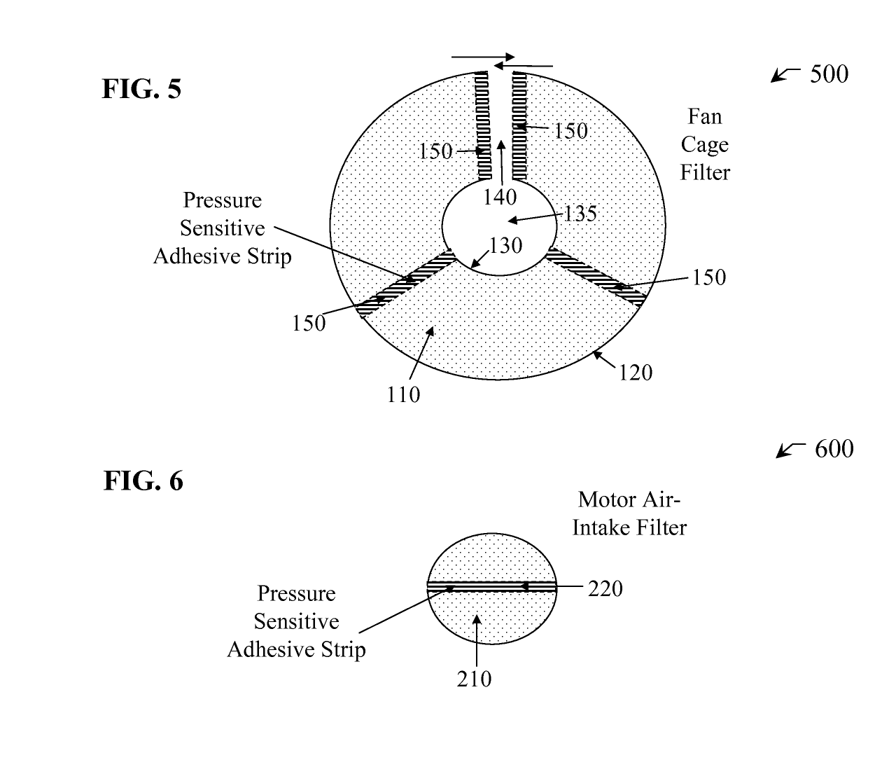

In some embodiments, the fastening mechanisms 150 are double-sided, pressure-sensitive adhesive strips and are arranged at twelve o'clock, four o'clock, and eight o'clock, as shown in FIG. 5. In some embodiments, the fastening mechanisms 150 are double-sided, pressure-sensitive adhesive strips and are arranged in some other pattern such that the fan cage filter 100 can be held securely to the fan cage. In some embodiments, the adhesive strips are peel and stick adhesive strips.

In some embodiments, the fan cage filter 100 is made of an air-permeable, allergen-reducing material 110. In some embodiments, the material 110 can trap pet dander, mold, bacteria, microparticles, dust, smoke, cooking odors, pollen, paper dust, road dust, and salt while still allowing normal airflow to pass through the fan inlet. In some embodiments, the fan cage filter 100 is made using an electrostatic filter material such as the Filtrete™ filter produced by 3M®. In some embodiments, the fan cage filter 100 can last up to thirty days under normal conditions. Allergen-reducing electrostatic filtration material such as Filtrete™ can be quite expensive. Therefore, in some embodiments, the fan cage filter 100 is sized so that it only covers the inlet surface of the fan cage that is perpendicular to the direction of the main air flow through the fan. Most incoming air will go through the inlet surface that is perpendicular to the main air-flow direction so sizing the fan cage filter 100 in this way does not significantly reduce filtration efficiency.

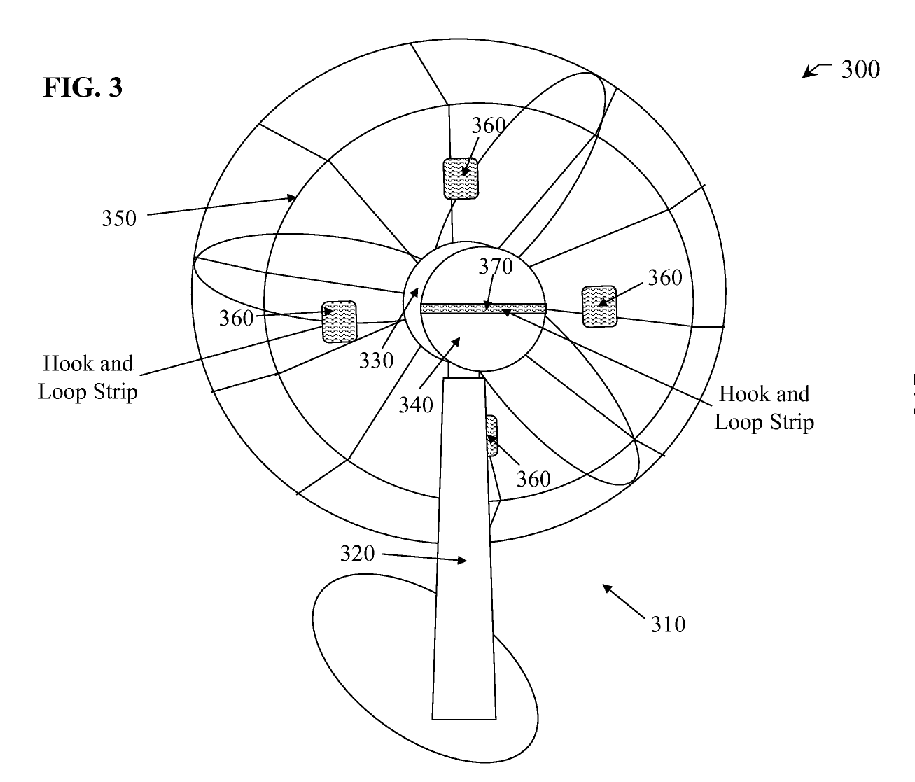

In some embodiments, the present invention provides a filter portion 200 for attaching to a motor air-intake of a portable electric fan, as shown in FIG. 2. In some embodiments, the filter portion 200 includes a shape and size that corresponds to a shape and size of the motor air-intake 340 shown in FIG. 3. In some embodiments, the filter portion 200 is made from the material that is cut to make the opening 135 in the fan cage filter 100. This saves on the expensive material costs that are associated with allergen-reducing electrostatic filtration material. In some embodiments, the filter portion 200 includes a plurality of fastening mechanisms 220. The plurality of fastening mechanisms 220 allow for easy installation and removal of the filter portion 200.

In some embodiments, the fastening mechanisms 220 are hook and loop strips, as shown in FIG. 2.

In some embodiments, the fastening mechanisms 220 are double-sided, pressure-sensitive adhesive strips, as shown in FIG. 6. In some embodiments, the adhesive strips are peel-and-stick adhesive strips.

In some embodiments, the filter portion 200 is made of an air-permeable, allergen-reducing material 210. In some embodiments, the material 210 can trap pet dander, mold, bacteria, microparticles, dust, smoke, cooking odors, pollen, paper dust, road dust, and salt while still allowing normal airflow to pass through the motor air-intake. In some embodiments, the filter portion 200 is an electrostatic filter such as the Filtrete™ filter produced by 3M®. In some embodiments, the filter portion 200 can last up to thirty days under normal conditions.

FIG. 3 is a perspective view of a portable electric fan having a fan cage, a motor casing, and a support stand, and that will be used with the claimed invention. In some embodiments, the present invention provides a filter portion generally annular in shape for attaching to a portable electric fan 310 having a fan cage 350, a motor casing 330, and a support stand 320, and that includes a circular outer periphery 120, an inner periphery 130 that forms a boundary around an opening 135 in the filter portion that is slightly smaller than an area of the motor casing 330, a slit 140 running from the outer periphery to the inner periphery to create a first end and a second end of the filter portion that allows the filter portion to be fitted around the support stand 320 and onto the fan cage 350, and a plurality of fastening mechanisms 150 for fastening the first end to the second end and for fastening the filter portion onto the inlet side of the fan cage 350. The plurality of fastening mechanisms 150 allow for easy installation and removal of the fan cage filter 100. In some embodiments, the fastening mechanisms 150 are used to connect the first end and the second end of the fan cage filter 100 by overlapping the two ends together as the fan cage filter 100 is placed on the inlet side of a fan cage. In some embodiments, the fan cage filter 100 is held onto the fan cage 350 via the suction created when the fan is turned on.

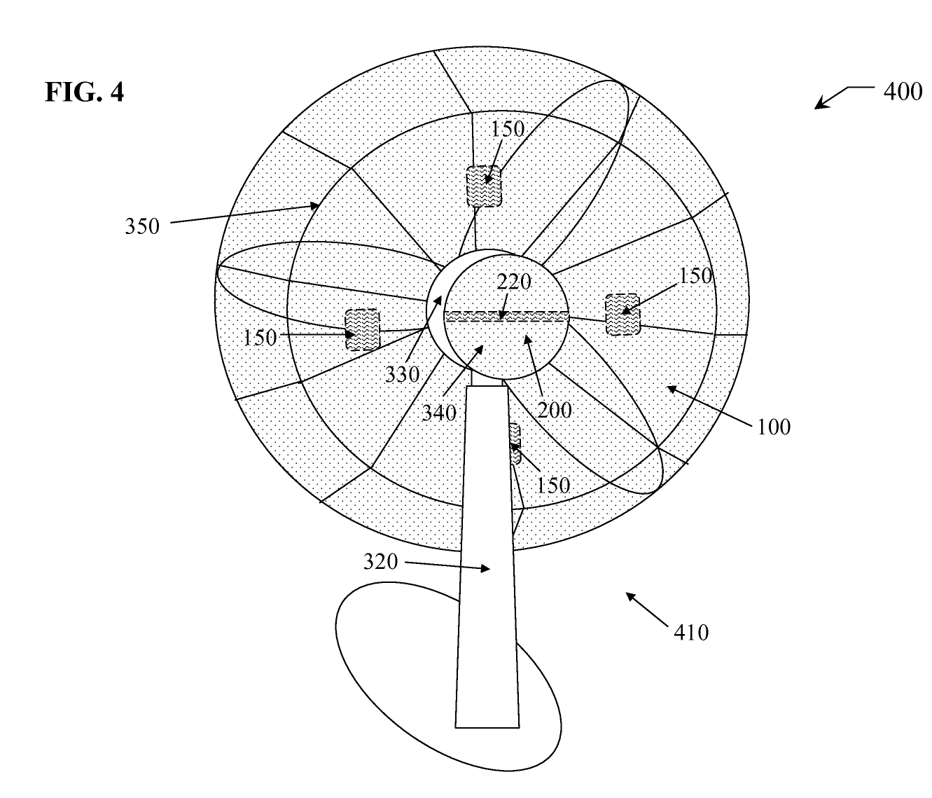

In some embodiments, the installed fan cage filter 100 fits securely to the inlet side of the fan cage 350 without any breaks in continuity such that all air flowing through the fan blades must pass through the fan cage filter 100. In some embodiments, the fan cage filter 100 covers the entire inlet side of the fan cage 350, as shown in FIGS. 4 and 7, and contains a fastening mechanism 150 that runs along the outer periphery 120 (outer periphery fastening mechanism not shown) so that the outer periphery 120 can fit securely to the plane of the fan cage 350 that is parallel to the main air flow through the fan. In other embodiments, in order to save on the filtration material costs discussed above, the fan cage filter 100 is sized so that it only covers the inlet surface of the fan cage that is perpendicular to the direction of the main air flow through the fan.

In some embodiments, the fan cage 350 has hook and loop strips 360 attached to it at twelve o'clock, three o'clock, six o'clock, and nine o'clock so that it can connect with fastening mechanisms 150 that are also hook and loop strips attached in the same pattern to the fan cage filter 100. In some embodiments, the fan motor air-intake has hook and loop strips 370 attached to it so that it can connect with fastening mechanisms 220 that are also hook and loop strips.

FIG. 4 is a perspective view of a portable electric fan with a fan cage filter and motor air-intake filter in place using hook and loop strips. The attachment of the fan cage filter 100 to the inlet side of the fan cage 350 and the attachment of the motor air-intake filter 200 to the motor air-intake 340 creates a complete air-filtration system 410 that filters all air flowing through the fan blades and fan motor.

FIG. 7 is a perspective view of a portable electric fan with a fan cage filter and motor air-intake filter in place using double-sided, pressure-sensitive adhesive strips. The attachment of the fan cage filter 500 to the inlet side of the fan cage 350 and the attachment of the motor air-intake filter 600 to the motor air-intake 340 creates a complete air filtration system 710 that filters all air flowing through the fan blades and fan motor.

In some embodiments, the present invention provides an air-filtration kit for attaching to a portable electric fan having a fan cage, a motor casing, and a support stand, the kit including a first filter portion, a second filter portion for attaching to a motor air-intake of a portable electric fan, and a set of instructions that provide guidance on how to assemble the air-filtration kit. In some embodiments, the first filter portion includes a circular outer periphery, an inner periphery that forms a boundary around an opening slightly smaller than an area of the motor casing, a slit running from the outer periphery to the inner periphery to create a first end and a second end of the filter portion that allows the filter portion to be fitted around the support stand and onto the fan cage, and a plurality of fastening mechanisms for fastening the first end to the second end and for fastening the filter portion onto the fan cage. In some embodiments, the second filter portion includes a shape and size that corresponds to a shape and size of the motor air-intake, and a plurality of fastening mechanisms.

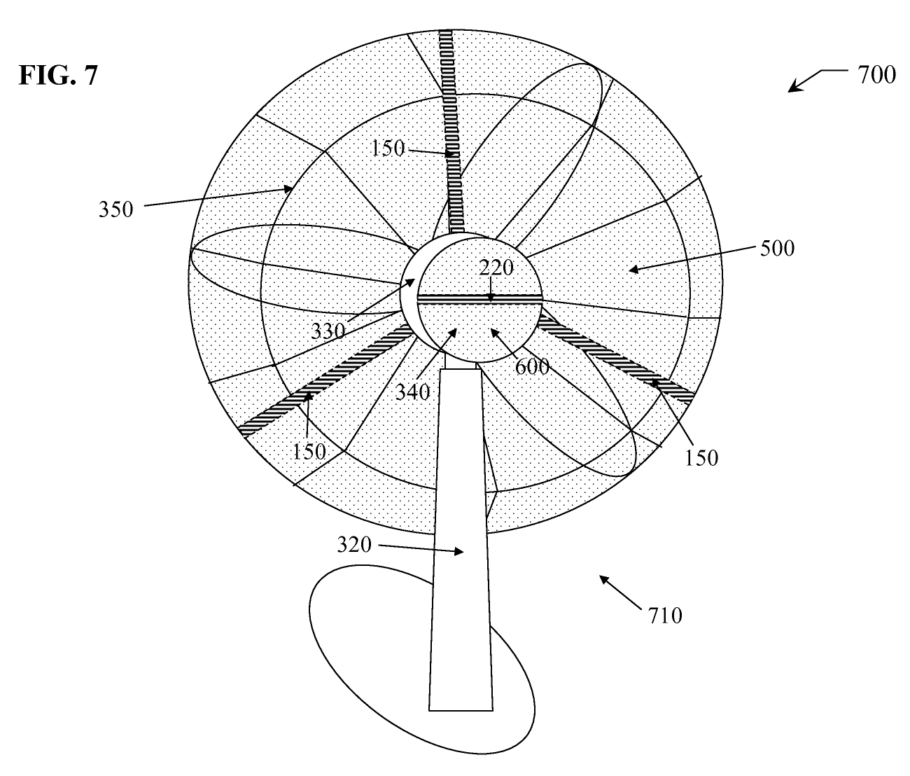

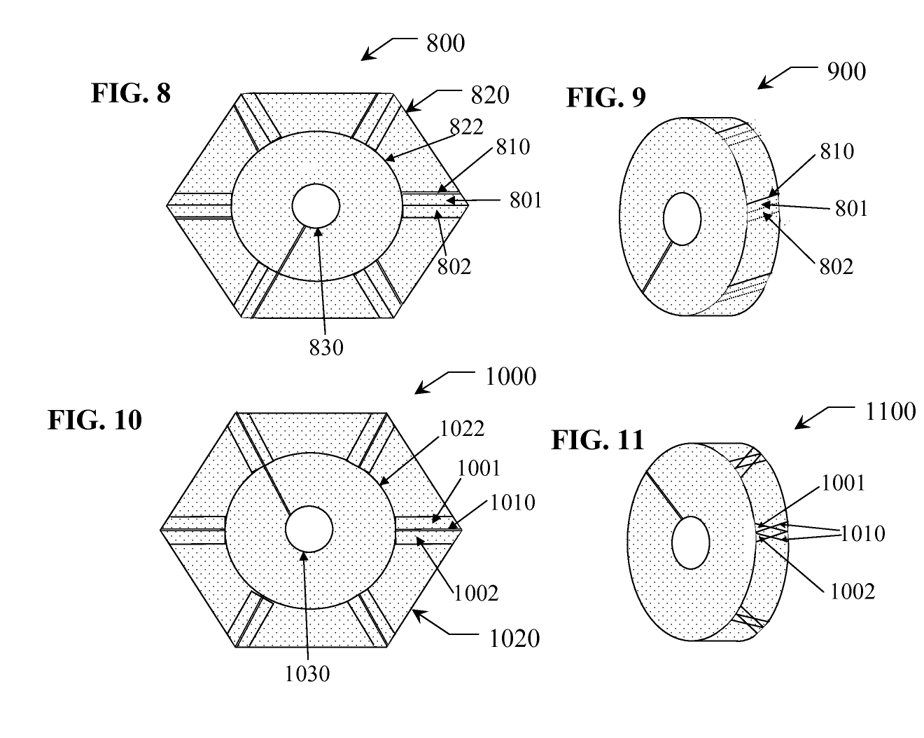

In some embodiments, the first filter portion in the air-filtration kit includes a hexagonal-shaped filter element 800 that includes a hexagonal outer periphery 820, a circular edge 822 (i.e., the outer back edge once folded as shown in FIG. 9) that corresponds to the outer back edge of the fan cage, and a circular inner periphery 830, as shown in FIG. 8. The hexagonal-shaped filter element 800 results in little wasted material during manufacturing and therefore allows the filter manufacturer to save money on the high costs of allergen-reducing electrostatic filter material. In some embodiments, the circular edge 822 is the same size as the outer periphery of the fan-cage inlet plane that is perpendicular to the main flow of air through the fan. In some embodiments, the inner periphery 830 form a boundary of an open area that is approximately the same size as the motor casing for the fan. In some embodiments, a slit 810 is cut near each point of the hexagon-shaped filter element 800, and in some embodiments, one of those slits extends to the inner periphery 830. In some embodiments, a plurality of fastening mechanisms 801 and 802 are attached to the back side of the filter element 800 such that each one of the plurality of both fastening mechanisms are to one side of a corresponding slit 810. The plurality of fastening mechanisms 801 and 802 allow for easy installation and removal of the filter element 800. In some embodiments, the plurality of fastening mechanisms 801 and 802 are double-sided, pressure-sensitive adhesive strips. In some embodiments, the two ends created by each slit 810 are connected by folding the ends together such that each one of the plurality of fastening mechanisms 801 connects one end to the other end and each one of the plurality of fastening mechanisms 802 connects the filter element 800 to the fan cage inlet, while also connecting the two ends together. FIG. 9 is a perspective view of a hexagonal-shaped filter element 800 folded to the shape 900 of a fan cage inlet.

In some embodiments, the first filter portion in the air filtration kit includes a hexagonal-shaped filter element 1000 that includes a hexagonal outer periphery 1020, a circular edge 1022 that corresponds to the outer back edge of the fan cage, and an inner periphery 1030, as shown in FIG. 10. The hexagonal-shaped filter element 1000 results in little wasted material during manufacturing and therefore allows the filter manufacturer to save money on the high costs of allergen-reducing electrostatic filter material. In some embodiments, the circular edge 1022 is the same size as the outer periphery of the fan-cage inlet plane that is perpendicular to the main flow of air through the fan. In some embodiments, the inner periphery 1030 form a boundary of an open area that is approximately the same size as the motor casing for the fan. In some embodiments, a slit 1010 is cut at each point of the hexagon-shaped filter element 1000, and in some embodiments, one of those slits extends to the inner periphery 1030. In some embodiments, a plurality of fastening mechanisms 1001 and 1002 are attached to the back side of the filter element 1000 such that each one of the plurality of fastening mechanism 1001 is on a first side of a slit 1010 and each one of the plurality of fastening mechanism 1002 is on a second side of a slit 1010. The plurality of fastening mechanisms 1001 and 1002 allow for easy installation and removal of the filter element 1000. In some embodiments, the plurality of fastening mechanisms 1001 and 1002 are double-sided, pressure-sensitive adhesive strips. In some embodiments, the two ends created by each slit 1010 are connected by folding the ends together such that the each one of the plurality fastening mechanisms 1001 forms a cross over a corresponding one of the plurality of fastening mechanisms 1002 whereby each one of the plurality of fastening mechanism forms a connection between the two ends and between the filter element 1000 and the fan cage inlet. FIG. 11 is a perspective view of a hexagonal-shaped filter element 1000 folded to a shape 1100 for being attached to a fan cage inlet.

In some embodiments, the hexagonal-shaped filter elements 800 and 1000 are made of an air-permeable, allergen-reducing material that can trap pet dander, mold, bacteria, microparticles, dust, smoke, cooking odors, pollen, paper dust, road dust, salt, and flying bugs and insects while still allowing normal air-flow to pass through the HVAC air-intake. In some embodiments, the hexagonal-shaped filter elements 800 and 1000 are electrostatic filters such as the Filtrete™ filter produced by 3M®. In some embodiments, the hexagonal-shaped filter elements 800 and 1000 can provide air filtration for approximately six months.

In some embodiments, the air-filtration kit can be used to filter air flowing through any type of standard household fan. In some embodiments, the air-filtration kit can be used to filter air flowing through pedestal fans. In some embodiments, the air-filtration kit can be used to filter air flowing through desk fans.

In some embodiments, the present invention provides a filter portion, the filter portion including a square-shaped outer periphery, and a plurality of fastening mechanisms. In some embodiments, the filter portion can be used to filter air flowing through a box fan. In other embodiments, the filter portion can be used to filter air flowing through a warehouse or industrial-sized fan. In some embodiments, the filter portion can be used to filter the air flowing through floor dyers. In some embodiments, the filter portion can be used to filter air flowing through a dehumidifier. In some embodiments, the filter portion can be used for exhaust fans, e.g., bathroom or kitchen exhaust fans. In some embodiments, the filter portion can be used for the fan in a microwave oven.

In some embodiments, the present invention provides a method that includes manufacturing a plurality of air-permeable filter sheets, determining a shape of a portable electric fan that includes a fan cage, a support stand, and a motor casing, measuring a size of an inlet side of the fan cage and a size of the motor casing, cutting the plurality of filter sheets such that a plurality of filter portions are created, and attaching a plurality of fastening mechanisms to each one of the plurality of filter portions. In some embodiments, each one of the plurality of filter portions fits around the support stand and motor casing and onto the fan cage.

In some embodiments, the present invention provides a method that includes manufacturing a plurality of air-permeable filter sheets, determining a shape of a portable electric fan that includes a fan cage, a support stand, and a motor casing, measuring a size of an inlet side of the fan cage and a size of the motor casing, cutting the plurality of filter sheets such that a plurality of filter portions are created, and attaching a plurality of fastening mechanisms to each one of the plurality of filter portions. In some embodiments, each one of the plurality of filter portions includes a hole that is slightly smaller than the size of the motor casing. In some embodiments, each one of the plurality of filter portions includes a slit for fitting the filter portion around the support stand and motor casing and onto the fan cage.

In some embodiments, the present invention provides a method that includes manufacturing a plurality of air-permeable filter sheets, determining a shape of a portable electric fan that includes a fan cage, a support stand, and a motor casing, measuring a size of an inlet side of the fan cage and a size of the motor casing, cutting the plurality of filter sheets such that a plurality of hexagonal-shaped filter portions are created, and attaching a plurality of fastening mechanisms to each one of the plurality of filter portions. In some embodiments, each one of the plurality of filter portions includes a hole that is slightly smaller than the size of the motor casing. In some embodiments, each one of the plurality of filter portions includes a slit at each point of the hexagon for securing the filter portion onto the fan cage and for fitting the filter portion around the support stand and motor casing.

In some embodiments, the present invention provides a method that includes manufacturing a plurality of air-permeable filter sheets, determining a shape of a portable electric fan having a fan cage, measuring a size of an inlet side of the fan cage, cutting the plurality of filter sheets such that a plurality of filter portion are created, and attaching a plurality of fastening mechanisms to each one of the plurality of filter portions. In some embodiments, each one of the plurality of filter portions covers the entire inlet side of the fan cage.

In some embodiments, the present invention provides a method that includes manufacturing a plurality of air-permeable filter sheets, determining a shape of a portable electric fan, wherein the fan includes a fan cage, a support stand, and a motor casing, measuring a size of an inlet side of the fan cage and a size of the motor casing, cutting the plurality of filter sheets such that a plurality of first filter portions and a plurality of second filter portions are created, and attaching a plurality of fastening mechanisms to each one of the plurality of first and second filter portions. In some embodiments, each one of the plurality of first filter portions fits around the support stand and motor casing and onto the fan cage. In some embodiments, each one of the plurality of second filter portions fits onto the motor casing and covers an air-intake on the motor casing.

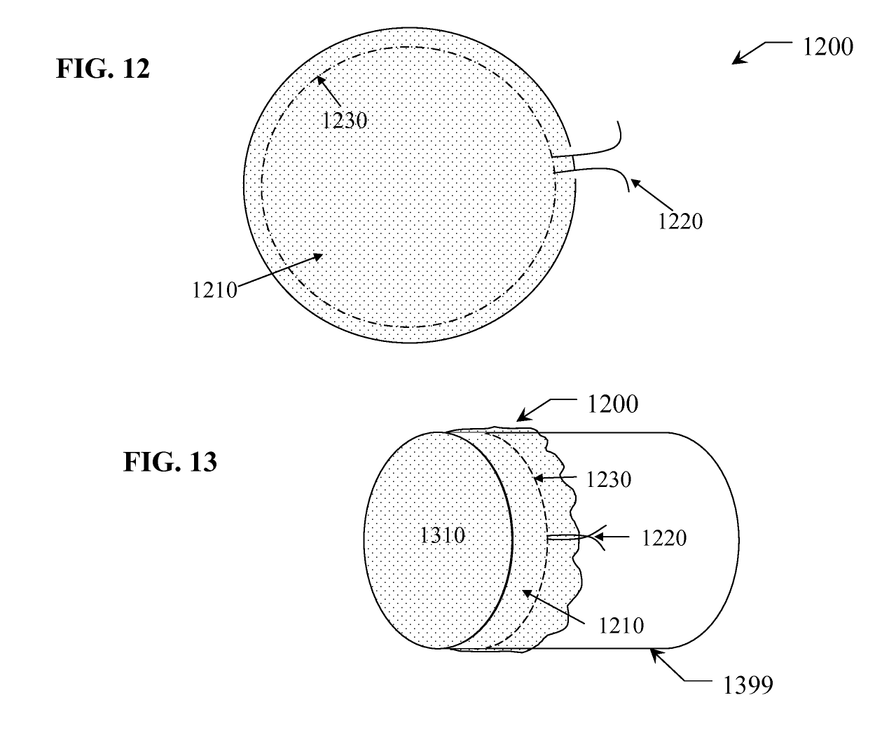

In some embodiments, the present invention provides an air filtration system for filtering the air entering a building's HVAC system. FIGS. 12 and 13 show one embodiment of the HVAC air-intake filtration system 1200. In some embodiments, the HVAC air-intake filtration system 1200 includes a bonnet-shaped filter element 1210 that is placed onto a building's HVAC system air-intake pipe 1399 such that all air entering the air-intake 1310 must pass through the filter element 1210. In some embodiments, the bonnet-shaped filter element 1210 includes a drawstring 1220 that is sewn into the edge 1230 of the filter element 1210 such that the filter element 1210 can be tightly fitted around the air-intake 1310 by tightening the drawstring 1220. In some embodiments, the bonnet-shaped filter element 1210 can be used on the air-intakes of large homes and buildings. In some embodiments, the bonnet-shaped filter element 1210 can be used on the air-intakes of smaller, 1-to-2 bedroom condos or apartments. In some embodiments, the bonnet-shaped filter element 1210 can be used to filter air leaving a building or home by securing the filter element 1210 on the exhaust of a building's HVAC system.

In some embodiments, the bonnet-shaped filter element 1210 is made of an air-permeable, allergen-reducing material that can trap pet dander, mold, bacteria, microparticles, dust, smoke, cooking odors, pollen, paper dust, road dust, salt, and flying bugs and insects while still allowing normal air-flow to pass through the HVAC air-intake. In some embodiments, the bonnet-shaped filter element 1210 is an electrostatic filter such as the Filtrete™ filter produced by 3M®. In some embodiments, the bonnet-shaped filter element 1210 can provide air filtration for approximately six months.

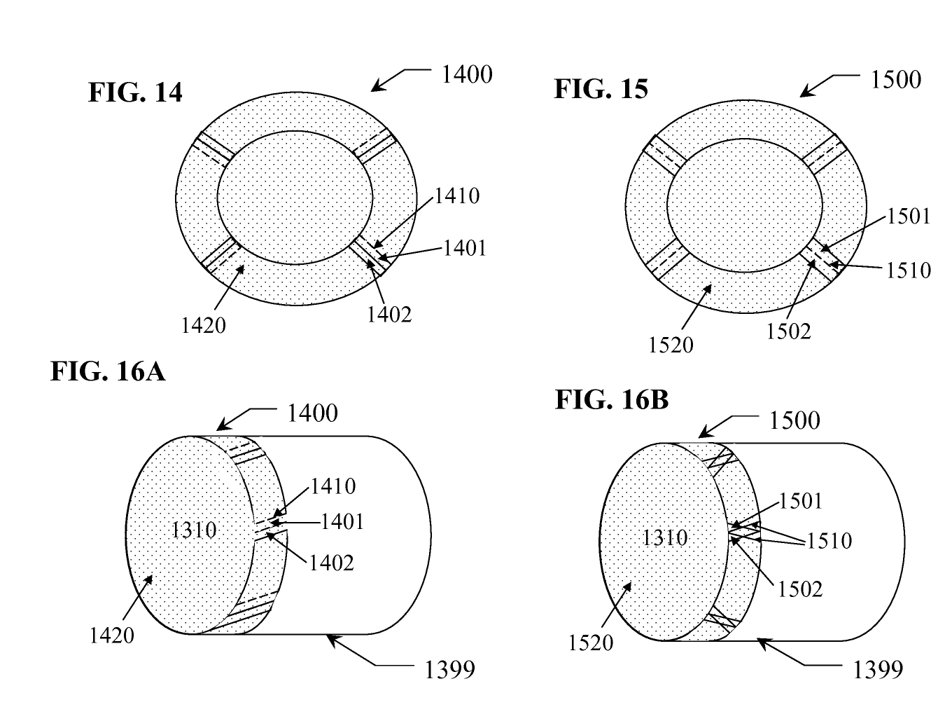

FIG. 14 is a schematic view of circular-shaped HVAC air-intake filtration system 1400. In some embodiments, the HVAC air-intake filtration system 1400 includes a circular-shaped filter element 1420 that is placed onto a building's HVAC system air-intake pipe 1399 such that all air entering the air-intake 1310 must pass through the filter element 1420. In some embodiments, a plurality of slits 1410 are cut inward along the periphery of the filter element 1420. In some embodiments, a plurality of fastening mechanisms 1401 and 1402 (such as double-sided pressure-sensitive adhesive tape) are attached to the back side of the filter element 1420 such that both fastening mechanisms are to one side of each one of the plurality of slits 1410. The plurality of fastening mechanisms 1401 and 1402 allow for easy installation and removal of the filter element 1420. In some embodiments, the plurality of fastening mechanisms 1401 and 1402 are double-sided, pressure-sensitive adhesive strips. In some embodiments, the two ends created by each one of the plurality of slits 1410 are connected by folding the ends together such that each one of the plurality of fastening mechanisms 1401 connects one end to the other end and each one of the plurality of fastening mechanisms 1402 connects the filter element 1420 to the air-intake pipe 1399, while also connecting the two ends together.

FIG. 16A is a perspective view of the filter element 1420 attached to an air-intake pipe 1399.

FIG. 15 is a schematic view of another embodiment of a circular-shaped HVAC air-intake filtration system. In some embodiments, the HVAC air-intake filtration system 1500 includes a circular-shaped filter element 1520 that is placed onto a building's HVAC system air-intake pipe 1399 such that all air entering the air-intake 1310 must pass through the filter element 1520. In some embodiments, a plurality of slits 1510 are cut along the periphery of the filter element 1520. In some embodiments, a plurality fastening mechanisms 1501 and 1502 are attached to the back side of the filter element 1520 such that each one of the plurality of fastening mechanisms 1501 is on a first side of each one of the plurality of slits 1510 and each one of the plurality of fastening mechanisms 1502 is on a second side of each one of the plurality of slits 1510. The plurality of fastening mechanisms 1501 and 1502 allow for easy installation and removal of the filter element 1520. In some embodiments, the plurality of fastening mechanisms 1501 and 1502 are double-sided, pressure-sensitive adhesive strips. In some embodiments, the two ends created by each one of the plurality of slits 1510 are connected by folding the ends together such that the plurality of fastening mechanisms 1501 and 1502 form a cross over each other whereby each fastening mechanism forms a connection between the two ends and between the filter element 1520 and the air-intake pipe 1399.

FIG. 16B is a perspective view of a circular-shaped filter element 1520 attached to a fan air-intake pipe 1399.

In some embodiments, the circular-shaped filter elements 1420 and 1520 can be used on the air-intakes of large homes and buildings. In some embodiments, the circular-shaped filter elements 1420 and 1520 can be used on the air-intakes of smaller, 1-to-2 bedroom condos or apartments. In some embodiments, the circular-shaped filter elements 1420 and 1520 can be used to filter air leaving a building or home by securing the filter elements 1420 or 1520 on the exhaust of a building's HVAC system.

In some embodiments, the circular-shaped filter elements 1420 and 1520 are made of an air-permeable, allergen-reducing material that can trap pet dander, mold, bacteria, microparticles, dust, smoke, cooking odors, pollen, paper dust, road dust, salt, and flying bugs and insects while still allowing normal air-flow to pass through the HVAC air-intake. In some embodiments, the circular-shaped filter elements 1420 and 1520 are electrostatic filters such as the Filtrete™ filter produced by 3M®. In some embodiments, the circular-shaped filter elements 1420 and 1520 can provide air filtration for approximately six months.

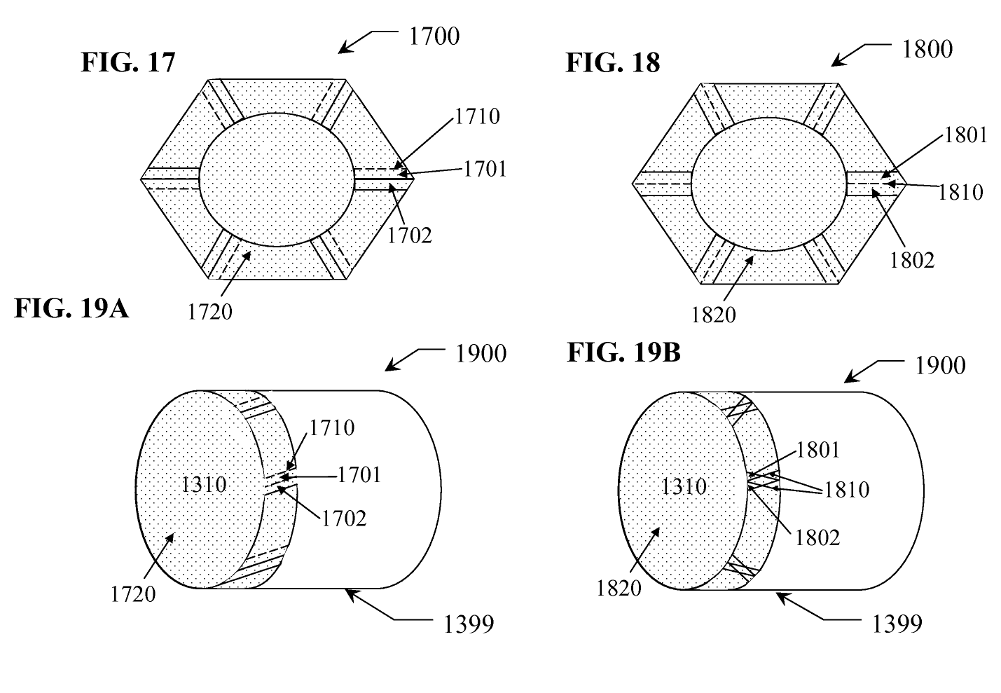

FIG. 17 shows a schematic view of a hexagonal-shaped HVAC air-intake filtration system with a slit near each point of the hexagon. In some embodiments, the HVAC air-intake filtration system 1700 includes a hexagonal-shaped filter element 1720 that is placed onto a building's HVAC system air-intake pipe 1399 such that all air entering the air-intake 1310 must pass through the filter element 1720. The hexagonal-shaped filter element 1720 results in little wasted material during manufacturing and therefore allows the filter manufacturer to save money on the high costs of allergen-reducing electrostatic filter material. In some embodiments, a slit 1710 is cut near each point of the hexagon-shaped filter element 1720. In some embodiments, a plurality of fastening mechanisms 1701 and 1702 are attached to the back side of the filter element 1720 such that each one of the plurality of both fastening mechanisms are to one side of a corresponding slit 1710. In other embodiments, the fastening mechanisms are attached around the outer periphery of the hexagonal filter element. In some embodiments, the plurality of fastening mechanisms 1701 and 1702 are double-sided, pressure-sensitive adhesive strips. In some embodiments, the two ends created by each slit 1710 are connected by folding the ends together such that each one of the plurality of fastening mechanisms 1701 connects one end to the other end and each one of the plurality of fastening mechanisms 1702 connects the filter element 1720 to the air-intake pipe 1399, while also connecting the two ends together. FIG. 19A is a perspective view of the filter element 1720 attached to an air-intake pipe 1399.

FIG. 18 shows a schematic view of another embodiment of hexagonal-shaped HVAC air-intake filtration system with a slit at each point of the hexagon. In some embodiments, the HVAC air-intake filtration system 1800 includes a hexagonal-shaped filter element 1820 that is placed onto a building's HVAC system air-intake pipe 1399 such that all air entering the air-intake 1310 must pass through the filter element 1820. The hexagonal-shaped filter element 1820 results in little wasted material during manufacturing and therefore allows the filter manufacturer to save money on the high costs of allergen-reducing electrostatic filter material. In some embodiments, a slit 1810 is cut at each point of the hexagon-shaped filter element 1820. In some embodiments, a plurality of fastening mechanisms 1801 and 1802 are attached to the back side of the filter element 1820 such that each one of the plurality of fastening mechanism 1801 is on a first side of a slit 1810 and each one of the plurality of fastening mechanism 1802 is on a second side of a slit 1810. In some embodiments, the plurality of fastening mechanisms 1801 and 1802 are double-sided, pressure-sensitive adhesive strips. In some embodiments, the two ends created by each slit 1810 are connected by folding the ends together such that the each one of the plurality fastening mechanisms 1801 forms a cross over a corresponding one of the plurality of fastening mechanisms 1802 whereby each one of the plurality of fastening mechanism forms a connection between the two ends and between the filter element 1800 and the air-intake pipe 1399. FIG. 19B is a perspective view of a hexagonal-shaped filter element 1800 attached to an air-intake pipe 1399.

In some embodiments, the hexagonal-shaped filter elements 1720 and 1820 can be used on the air-intakes of large homes and buildings. In some embodiments, the hexagonal-shaped filter elements 1720 and 1820 can be used on the air-intakes of smaller, 1-to-2 bedroom condos or apartments. In some embodiments, the hexagonal-shaped filter elements 1720 and 1820 can be used to filter air leaving a building or home by securing the filter elements 1720 or 1820 on the exhaust of a building's HVAC system.

In some embodiments, the hexagonal-shaped filter elements 1720 and 1820 are made of an air-permeable, allergen-reducing material that can trap pet dander, mold, bacteria, microparticles, dust, smoke, cooking odors, pollen, paper dust, road dust, salt, and flying bugs and insects while still allowing normal air-flow to pass through the HVAC air-intake. In some embodiments, the hexagonal-shaped filter elements 1700 and 1800 are electrostatic filters such as the Filtrete™ filter produced by 3M®. In some embodiments, the hexagonal-shaped filter elements 1700 and 1800 can provide air filtration for approximately six months.

In some embodiments, the present invention provides an apparatus for filtering air passing through a portable electric fan, the fan having a stand supporting a motor, the motor having a motor casing and a motor shaft, the fan further having a set of fan blades attached to the motor shaft and a protective cage surrounding the fan blades, the apparatus including: a first filter portion made of a fibrous material, the first filter portion including: an outer periphery having a shape that conforms generally to an outer shape of a fan to which the first filter portion will attach; an inner periphery, wherein the inner periphery forms a boundary around an opening in the filter portion; a slit running from the outer periphery to the inner periphery, wherein the slit creates a first end and a second end of the filter portion; and one or more adhering fastening mechanisms attached to the first filter portion for attaching the first filter portion to the protective cage, and wherein the slit and the opening are configured so that the first filter portion can be fitted around the motor casing and attached to the protective cage on an air-inlet side of the protective cage of the portable electric fan.

In some embodiments, the plurality of fastening mechanisms are configured to fasten the first end to the second end by overlapping the two ends together.

Some embodiments further include hook-side hook-and-loop fasteners (i.e., the half of a set of hook-and-loop fasteners having an adhesive surface for attaching to the cage and a hook-side surface configured to attach directly to the fibrous material.

Some embodiments further include a second filter portion having one or more adhering fastening mechanisms configured for attaching to a motor air-intake portion of the motor of the electric fan, wherein the second filter portion includes a shape and a size the corresponds to a shape and a size of the motor air-intake.

In some embodiments, the outer periphery of the first filter portion is generally square in shape.

In some embodiments, the one or more fastening mechanisms of the first filter portion include one or more hook and loop strips.

In some embodiments, the one or more fastening mechanisms of the first filter portion include pressure-sensitive adhesive strips.

In some embodiments, the plurality of fastening mechanisms of the first filter portion includes a drawstring that is sewn into an edge of the outer periphery such that the first filter portion can be secured tightly on an air-intake of an HVAC system by tightening the drawstring around a periphery of the air-intake.

In some embodiments, the present invention provides a method that includes manufacturing a plurality of air-permeable filter sheets of a fibrous material; determining a size and shape of an inlet side of a fan cage on a portable electric fan, the fan having a stand supporting a motor, the motor having a motor casing and a motor shaft, the fan further having a set of fan blades attached to the motor shaft and a protective cage surrounding the fan blades; cutting the plurality of filter sheets such that a plurality of filter portions are created, wherein each one of the plurality of filter portions has a shape and a size that corresponds to the shape and size of the inlet side of the fan cage including an outer periphery having a shape that conforms generally to an outer shape of a fan to which the first filter portion will attach, an inner periphery, wherein the inner periphery forms a boundary around an opening in the filter portion, a slit running from the outer periphery to the inner periphery, wherein the slit creates a first end and a second end of the filter portion; and attaching one or more fastening mechanisms to each one of the plurality of filter portions.

In some embodiments, the plurality of fastening mechanisms are configured to fasten the first end to the second end by overlapping the two ends of one of the cut plurality of filter sheets together.

Some embodiments of the method further include packaging into a kit at least one of the cut plurality of filter sheets and one or more hook-side hook-and-loop fasteners having an adhesive surface for attaching to the cage and a hook-side surface configured to attach directly to the fibrous material.

Some embodiments of the method further include packaging, in the kit, a second filter portion having one or more adhering fastening mechanisms configured for attaching to a motor air-intake portion of the motor of the electric fan, wherein the second filter portion includes a shape and a size the corresponds to a shape and a size of the motor air-intake.

In some embodiments, the outer periphery of the first filter portion is generally square in shape.

In some embodiments, the one or more fastening mechanisms of the first filter portion include one or more hook and loop strips.

In some embodiments, the one or more fastening mechanisms of the first filter portion include one or more pressure-sensitive adhesive strips.

In some embodiments, the plurality of fastening mechanisms of the first filter portion includes a drawstring that is sewn into an edge of the outer periphery such that the first filter portion can be secured tightly on an air-intake of an HVAC system by tightening the drawstring around a periphery of the air-intake.

In some embodiments, the present invention provides an apparatus for filtering air passing through a portable electric fan, the fan having a support stand supporting a motor, the motor having a motor casing and a motor shaft, the fan further having a set of fan blades attached to the motor shaft and a protective cage surrounding the fan blades. This apparatus includes an air filtration kit for attaching to the portable electric fan, the kit including: filter material means forming a first portion for attaching to the fan cage for filtering air passing through the fan cage and a second filter portion for attaching to the fan motor and filtering air passing through the motor; and means for fitting a first filter portion around the support stand and the motor casing of the electric fan; means for fastening the first filter portion onto a fan cage of the electric fan.

Some embodiments further include means for fitting a second filter portion onto a motor casing of the portable electric fan such that an air-intake on the motor casing is completely covered.

In some embodiments, the means for fastening include one or more hook and loop strips.

In some embodiments, the means for fastening include one or more pressure-sensitive adhesive strips.

In some embodiments, the present invention provides a method that includes manufacturing a plurality of air-permeable filter sheets, measuring a size of an air-intake for a building's HVAC system, cutting the plurality of filter sheets such that a plurality of hexagonal-shaped HVAC air-intake filter portions are created, and attaching a plurality of fastening mechanisms to each one of the plurality of hexagonal-shaped HVAC air-intake filter portions.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. An apparatus for filtering air entering an air-intake pipe of a building, the apparatus comprising:
a first filter element made of a fibrous material; and
one or more fastening mechanisms, wherein the one or more fastening mechanisms are configured to fasten the first filter element to the air-intake pipe, and wherein the one or more fastening mechanisms are attached to the first filter element such that the one or more filter mechanisms do not cover any portion of the first filter element through which the air flows as the air enters the air-intake pipe.

2. The apparatus of claim 1, wherein the one or more fastening mechanisms include a drawstring that is sewn into a periphery of the first filter element.

3. The apparatus of claim 1, wherein the first filter element includes a plurality of slits cut inward from an outer edge of the first filter element such that a periphery of the first filter element is divided into a plurality of segments, wherein the one or more fastening mechanisms are located along the periphery of the first filter element, and wherein the one or more fastening mechanisms include double-sided pressure-sensitive adhesive strips.

4. The apparatus of claim 3, wherein at least two adhesive strips are positioned on a first side of each one of the plurality of slits, wherein a first one of the at least two adhesive strips connects adjacent segments of the plurality of segments together, and wherein a second one of the at least two adhesive strips connects the first filter element to the air-intake pipe.

5. The apparatus of claim 3, wherein at least one adhesive strip is positioned on a first side of each one of the plurality of slits and at least one adhesive strip is positioned on a second side of each one of the plurality of slits, and wherein each one of the adhesive strips connects adjacent segments of the plurality of segments together and connects the first filter element to the air-intake pipe.

6. The apparatus of claim 1, wherein the first filter element includes a periphery that is generally circular in shape.

7. The apparatus of claim 1, wherein the first filter element includes a periphery that is generally hexagonal in shape.

8. The apparatus of claim 1, wherein the fibrous material used to make the first filter element is an allergen-reducing electrostatic filter material.

9. The apparatus of claim 1, wherein the first filter element includes a plurality of slits cut inward from an outer edge of the first filter element such that a periphery of the first filter element is divided into a plurality of segments, wherein the one or more fastening mechanisms are located along the periphery of the first filter element, wherein the one or more fastening mechanisms include double-sided pressure-sensitive adhesive strips, and wherein the periphery of the first filter element is generally hexagonal in shape.

10. A method comprising:
manufacturing a plurality of air-permeable filter sheets of a fibrous material;
determining a size and shape of an air-intake pipe of a building;
cutting the plurality of filter sheets such that a plurality of filter elements are created, wherein each one of the plurality of filter portions has a shape and a size that corresponds to the shape and size of the air-intake pipe of the building; and
attaching one or more fastening mechanisms to each one of the plurality of filter elements, wherein the one or more fastening mechanisms are configured to fasten the plurality of filter elements to the air-intake pipe.

11. The method of claim 10, wherein the one or more fastening mechanisms include double-sided pressure-sensitive adhesive strips, the method further comprising
packaging into a kit at least one of the plurality of filter elements having the attached one or more double-sided pressure-sensitive adhesive strips.

12. The method of claim 10, wherein the cutting includes cutting the plurality of filter sheets such that each one of the plurality of filter elements has a periphery that is generally circular in shape.

13. The method of claim 10, wherein the manufacturing includes manufacturing a plurality of allergen-reducing electrostatic filter sheets.

14. The method of claim 10, wherein the one or more fastening mechanisms include a drawstring that is sewn into a periphery of each one of the plurality of filter elements.

15. The method of claim 10, wherein the one or more fastening mechanisms include double-sided pressure-sensitive adhesive strips.

16. An apparatus for filtering air entering an air-intake pipe of a building, the apparatus comprising:
an air-filtration kit for attaching to the air-intake pipe, the kit including:
filter material means for attaching to air-intake pipe; and
means for fastening the filter material means onto the air-intake pipe.

17. The apparatus of claim 16, wherein the means for fastening includes drawstring means.

18. The apparatus of claim 16, wherein the means for fastening includes adhesive means.

19. The apparatus of claim 16, wherein the filter material means includes a periphery that is generally circular in shape.

20. The apparatus of claim 16, wherein the filter material means includes a periphery that is generally hexagonal in shape.
